(19) United States
(12) Patent Application Publication
(10) Pub. No.: US 2025/0369826 A1
(43) Pub. Date: Dec. 4, 2025

(54) Signal Processing Method, Signal Processing Apparatus, Signal Processing System, And Non-Transitory Computer-Readable Storage Medium Storing Signal Processing Program

(71) Applicant: SEIKO EPSON CORPORATION, Tokyo (JP)

(72) Inventors: Ryosuke OMURA, Matsumoto (JP); Kenta SATO, Shiojiri (JP)

(21) Appl. No.: 19/223,503

(22) Filed: May 30, 2025

(30) Foreign Application Priority Data
May 31, 2024 (JP) 2024-088754

(51) Int. Cl. G01M 13/045

(52) U.S. Cl. CPC G01M 13/045

(57) ABSTRACT

A signal processing method includes generating a first Lissajous figure based on a physical quantity generated by a vibration in a first period, generating an i-th Lissajous figure based on a physical quantity generated by a vibration in an i-th period with respect to each integer i from 2 to N, N being an integer of 2 or more, and calculating an (i−1)-th degree of difference as a degree of difference between the first Lissajous figure and the i-th Lissajous figure.

The present application is based on, and claims priority from JP Application Serial Number 2024-088754, filed May 31, 2024, the disclosure of which is hereby incorporated by reference herein in its entirety.

### BACKGROUND

### 1. Technical Field

The present disclosure relates to a signal processing method, a signal processing apparatus, a signal processing system, and a non-transitory computer-readable storage medium storing a signal processing program.

### 2. Related Art

JP-A-2000-258305 discloses an abnormality diagnostic apparatus for a rotating device bearing portion, including vibration detection means for respectively detecting vibrations at predetermined positions on at least two axes orthogonal to each other on the same plane around a shaft center of a rotating device and outputting vibration waveform signals, Lissajous waveform diagram generation means for generating a Lissajous waveform diagram based on the vibration waveform signals, reference Lissajous waveform diagram setting means for setting and storing a plurality of reference Lissajous waveform diagrams assumed based on a cause of each abnormality in advance, and abnormality cause determination means for comparing the Lissajous waveform diagram with the reference Lissajous waveform diagrams to determine and output a cause of an abnormality.

JP-A-2000-258305 is an example of the related art.

In the method disclosed in JP-A-2000-258305, since time and effort to prepare a plurality of reference Lissajous waveform diagrams assumed based on a cause of each abnormality in advance is necessary, and the Lissajous waveform diagram and each reference Lissajous waveform diagram are compared and the cause of the abnormality is determined based on which is similar, it is difficult to determine presence or absence of an abnormality when an unexpected abnormality occurs.

### SUMMARY

A signal processing method according to an aspect of the present disclosure includes generating a first Lissajous figure based on a physical quantity generated by a vibration in a first period, generating an i-th Lissajous figure based on a physical quantity generated by a vibration in an i-th period with respect to each integer i from 2 to N, N being an integer of 2 or more, and calculating an (i−1)-th degree of difference as a degree of difference between the first Lissajous figure and the i-th Lissajous figure.

A signal processing apparatus according to an aspect of the present disclosure includes a Lissajous figure generation circuit that generates a first Lissajous figure based on a physical quantity generated by a vibration in a first period and generates an i-th Lissajous figure based on a physical quantity generated by a vibration in an i-th period with respect to each integer i from 2 to N, N being an integer of 2 or more, and a degree of difference calculation circuit that calculates an (i−1)-th degree of difference as a degree of difference between the first Lissajous figure and the i-th Lissajous figure.

A signal processing system according to an aspect of the present disclosure includes the signal processing apparatus according to the aspect, and at least one physical quantity sensor that detects the physical quantity generated by the vibration in each of the first to N-th periods.

A non-transitory computer-readable storage medium storing a signal processing program according to an aspect of the present disclosure, in which the program causes a computer to execute generating a first Lissajous figure based on a physical quantity generated by a vibration in a first period, generating an i-th Lissajous figure based on a physical quantity generated by a vibration in an i-th period with respect to each integer i from 2 to N, N being an integer of 2 or more, and calculating an (i−1)-th degree of difference as a degree of difference between the first Lissajous figure and the i-th Lissajous figure.

### BRIEF DESCRIPTION OF THE DRAWINGS

FIG. 1 is a flowchart showing a procedure of a signal processing method of a first embodiment.

FIG. 2 is a flowchart showing an example of a detailed procedure of step S60 in FIG. 1.

FIG. 3 shows a method of calculating a degree of difference.

FIG. 4 shows a configuration example of a signal processing apparatus that executes the signal processing method of the first embodiment.

FIG. 5 is a flowchart showing a procedure of a signal processing method of a second embodiment.

FIG. 6 is a graph of transition information.

FIG. 7 shows a configuration example of a signal processing apparatus that executes the signal processing method of the second embodiment.

FIG. 8 is a flowchart showing a procedure of a signal processing method of a third embodiment.

FIG. 9 shows an example of interpolation of a Lissajous figure.

FIG. 10 shows a configuration example of a signal processing apparatus that executes the signal processing method of the third embodiment.

FIG. 11 is a flowchart showing a procedure of a signal processing method of a fourth embodiment.

FIG. 12 shows a configuration example of a signal processing apparatus that executes the signal processing method of the fourth embodiment.

FIG. 13 shows a configuration example of a signal processing system of an embodiment.

FIG. 14 is a schematic perspective view showing a configuration of a vacuum pump.

FIG. 15 is a schematic side sectional view showing an internal structure of the vacuum pump.

FIG. 16 is a schematic plan sectional view showing the internal structure of the vacuum pump.

### DESCRIPTION OF EMBODIMENTS

As below, preferred embodiments of the present disclosure will be described in detail using the drawings. Note that the embodiments to be described below do not unduly limit the present disclosure described in What is claimed is. In addition, not all configurations to be described below are necessarily essential component elements of the present disclosure.

### 1. Signal Processing Method and Signal Processing Apparatus

### 1-1. First Embodiment

### 1-1-1. Signal Processing Method

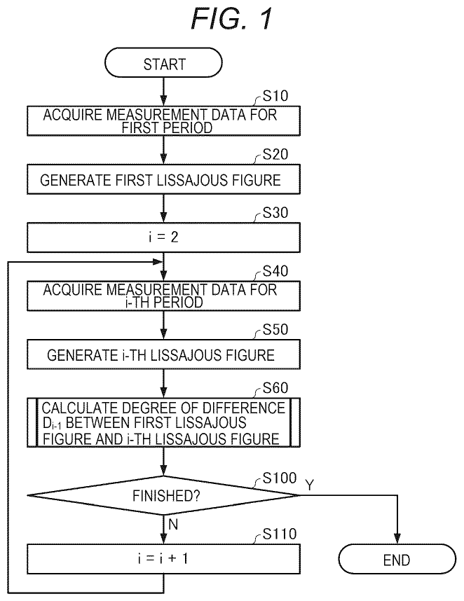

FIG. 1 is a flowchart showing a procedure of a signal processing method of a first embodiment. The signal processing method of the first embodiment is executed by, for example, a signal processing apparatus 100 operating according to a signal processing program. A configuration example of the signal processing apparatus 100 that executes the signal processing method of the first embodiment will be described later.

As shown in FIG. 1, first, in step S10, the signal processing apparatus 100 acquires measurement data in a first period. The measurement data is data based on a signal output from a physical quantity sensor that detects physical quantities on a plurality of axes generated by a vibration of an object. The measurement data may be time-series data of a digital signal output from a physical quantity sensor, or time-series data of a digital signal obtained by conversion of an analog signal output from the physical quantity sensor by an analog front-end.

The first period is a period having an optional length, and the measurement data for the first period is time-series data of the physical quantities on the plurality of axes detected by the physical quantity sensor in the first period. The physical quantity sensor may detect the physical quantity divisionally at a plurality of times in the first period and output measurement data for the plurality of times, and the signal processing apparatus 100 may acquire the measurement data for the plurality of times. For example, when the first period is a period of one day and the physical quantity sensor detects the physical quantity at six times every four hours, the signal processing apparatus 100 may acquire measurement data for the six times.

The plurality of axes on which the physical quantity sensor detects the physical quantities may be, for example, two axes, three axes, or more axes. The plurality of axes preferably intersect each other and are orthogonal to each other. The physical quantity sensor may be, for example, a sensor using MEMS vibrator or a sensor using a quartz crystal vibrator. MEMS is an abbreviation for Micro Electro Mechanical Systems. The physical quantity sensor may be built in one device such as an IMU, or at least one of a plurality of sensors that detect physical quantities of the respective axes may be physically separated from the other sensors. IMU is an abbreviation for Inertial Measurement Unit.

The object is an object to be subjected to signal processing and the type of the object is not particularly limited. The object may be, for example, various devices such as a motor having a rotation mechanism or a vibration mechanism, a structure such as a bridge or a building that vibrates due to an external force, or an electric circuit that generates a signal having periodicity. The type of the physical quantity generated by the vibration of the object is not particularly limited, and for example, the physical quantity may be an acceleration, an angular velocity, a velocity, displacement, pressure, a current, a voltage, or the like.

Then, in step S20, the signal processing apparatus 100 generates a first Lissajous figure based on the measurement data in the first period acquired in step S10. That is, in step S20, the signal processing apparatus 100 generates the first Lissajous figure based on the physical quantity generated by the vibration of the object in the first period. For example, when the physical quantity sensor detects each physical quantity on the X axis and the Y axis and the measurement data for the first period includes the time-series data of the physical quantity on the X axis and the time-series data of the physical quantity on the Y axis, the signal processing apparatus 100 may generate a Lissajous figure on a two-dimensional plane with the first axis as the X axis and the second axis as the Y axis. When the physical quantity sensor detects each physical quantity on the X axis, the Y axis, and the Z axis and the measurement data for the first period includes the time-series data of the physical quantity on the X axis, the time-series data of the physical quantity on the Y axis, and the time-series data of the physical quantity on the Z axis, the signal processing apparatus 100 may generate a Lissajous figure in a three-dimensional space with the first axis as the X axis, the second axis as the Y axis, and the third axis as the Z axis. In this case, the signal processing apparatus 100 may generate at least one of a Lissajous figure on a two-dimensional plane with the first axis as the X axis and the second axis as the Y axis, a Lissajous figure on a two-dimensional plane with the first axis as the Y axis and the second axis as the Z axis, and a Lissajous figure on a two-dimensional plane with the first axis as the Z axis and the second axis as the X axis.

Further, when acquiring measurement data for a plurality of times in step S10, the signal processing apparatus 100 may generate a plurality of Lissajous figures based on the measurement data for the plurality of times and average the plurality of Lissajous figures to generate a first Lissajous figure in step S20. For example, when the first period is a period of one day and the physical quantity sensor detects the physical quantity at six times every four hours, the signal processing apparatus 100 may generate six Lissajous figures based on the measurement data for the six times and average the six Lissajous figures to generate the first Lissajous figure.

Then, the signal processing apparatus 100 sets an integer i to 2 in step S30, and acquires measurement data for the i-th period in step S40. The measurement data is data based on a signal output from a physical quantity sensor that detects physical quantities on a plurality of axes generated by a vibration of an object. The measurement data may be time-series data of a digital signal output from a physical quantity sensor, or time-series data of a digital signal obtained by conversion of an analog signal output from the physical quantity sensor by an analog front-end.

The i-th period is a period having an optional length, and the measurement data for the i-th period is time-series data of the physical quantities on the plurality of axes detected by the physical quantity sensor in the i-th period. The physical quantity sensor may detect the physical quantity divisionally at a plurality of times in the i-th period and output measurement data for the plurality of times, and the signal processing apparatus 100 may acquire the measurement data for the plurality of times. For example, when the i-th period is a period of one day and the physical quantity sensor detects the physical quantity at six times every four hours, the signal processing apparatus 100 may acquire measurement data for the six times.

The plurality of axes on which the physical quantity sensor detects the physical quantities may be, for example, two axes, three axes, or more axes. The plurality of axes preferably intersect each other and are orthogonal to each other. The physical quantity sensor may be, for example, a sensor using MEMS vibrator or a sensor using a quartz crystal vibrator. The physical quantity sensor may be built in one device such as an IMU, or at least one of a plurality of sensors that detect physical quantities of the respective axes may be physically separated from the other sensors.

In the embodiment, the physical quantity sensor that outputs the measurement data for the first period and the physical quantity sensor that outputs the measurement data for the i-th period may be the same or different. In the latter case, two physical quantity sensors may detect the same type of physical quantity. The object whose physical quantity is detected in the first period and the object whose physical quantity is detected in the i-th period may be the same or different. In the latter case, the two objects may be objects of the same type, for example, devices of the same model number.

Then, in step S50, the signal processing apparatus 100 generates an i-th Lissajous figure based on the measurement data for the i-th period acquired in step S40. That is, in step S50, the signal processing apparatus 100 generates the i-th Lissajous figure based on the physical quantity generated by the vibration of the object in the i-th period. Each axis of the first Lissajous figure is the same as each axis of the i-th Lissajous figure.

When the signal processing apparatus 100 acquires measurement data for a plurality of times in step S40, the signal processing apparatus 100 may generate a plurality of Lissajous figures based on the measurement data for the plurality of times and average the plurality of Lissajous figures to generate an i-th Lissajous figure in step S50. For example, when the i-th period is a period of one day and the physical quantity sensor detects the physical quantity at six times every four hours, the signal processing apparatus 100 may generate six Lissajous figures based on the measurement data for the six times and average the six Lissajous figures to generate the i-th Lissajous figure.

Then, in step S60, the signal processing apparatus 100 calculates a degree of difference Dᵢ₋₁ between the first Lissajous figure generated in step S20 and the i-th Lissajous figure generated in step S50. For example, when the integer i is 2, the signal processing apparatus 100 calculates a degree of difference Di between the first Lissajous figure and the second Lissajous figure in step S60.

Then, the signal processing apparatus 100 increments the integer i by 1 in step S110 and repeatedly performs steps S40 to S60 until the signal processing is finished in step S100.

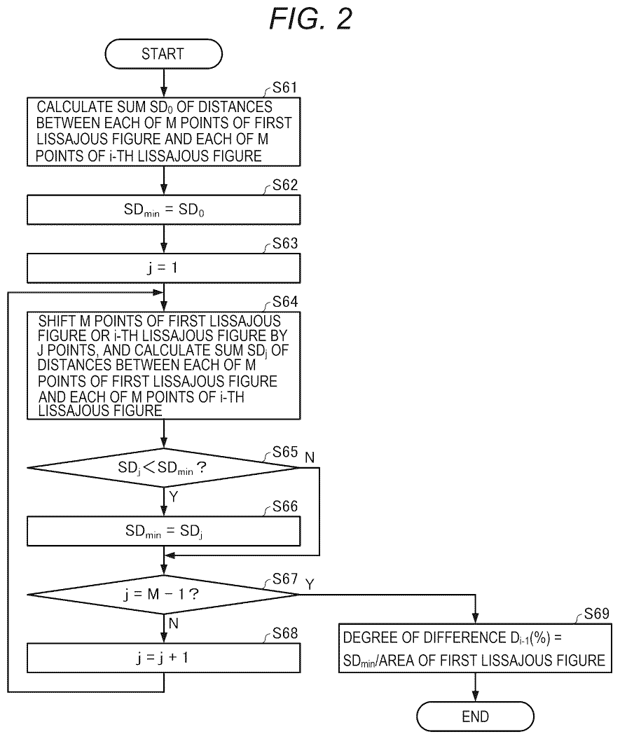

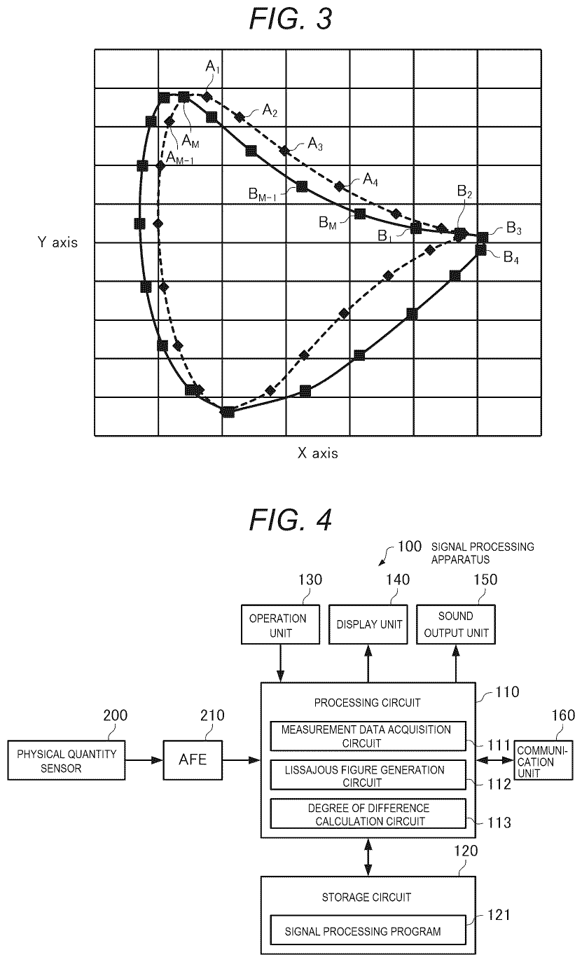

FIG. 2 is a flowchart showing an example of a detailed procedure of step S60 in FIG. 1. As shown in FIG. 2, first, in step S61, the signal processing apparatus 100 calculates a sum SD₀ of distances between each of M points of the first Lissajous figure and each of M points of the i-th Lissajous figure. M is an integer of two or more. For example, as shown in FIG. 3, in a two-dimensional plane formed by an X axis and a Y axis, when the first Lissajous figure indicated by a broken line includes M points A₁ to A_{M} and the i-th Lissajous figure indicated by a solid line includes M points B₁ to B_{M}, the signal processing apparatus 100 calculates SD₀ using Expression (1). In Expression (1), X₁ₖ is the X-coordinate of the point Aₖ, and Y₁ₖ is the Y-coordinate of the point Aₖ. Further, X₁ₖ is the X-coordinate of the point Bₖ, and Yᵢₖ is the Y-coordinate of the point Bₖ.

$$S {D}_{0} = {\sum }_{k = 1}^{M} \sqrt{{( {X}_{1 k} - {X}_{ik} )}^{2} + {( {Y}_{1 k} - {Y}_{ik} )}^{2}} \qquad ( 1 )$$

When the first Lissajous figure and the i-th Lissajous figure are drawn in a three-dimensional space formed by an X axis, a Y axis, and a Z axis, the signal processing apparatus 100 can calculate SD₀ using Expression (2). In Expression (2), X₁ₖ is the X-coordinate of the point Aₖ, Y₁ₖ is the Y-coordinate of the point Aₖ, and Z₁ₖ is the Z coordinate of the point Aₖ. Further, Xᵢₖ is the X-coordinate of the point Bₖ, Yᵢₖ is the Y-coordinate of the point Bₖ, and Zᵢₖ is the Z coordinate of the point Bₖ.

$$S {D}_{0} = {\sum }_{k = 1}^{M} \sqrt{{( {X}_{1 k} - {X}_{ik} )}^{2} + {( {Y}_{1 k} - {Y}_{i k} )}^{2} + {( {Z}_{1 k} - {Z}_{i k} )}^{2}} \qquad ( 2 )$$

Then, the signal processing apparatus 100 sets the minimum value SDₘᵢₙ=SD₀ in step S62, and sets an integer j to 1 in step S63.

Then, in step S64, the signal processing apparatus 100 shifts the M points of the first Lissajous figure or the i-th Lissajous figure by j points, and calculates a sum SDⱼ of distances between each of the M points of the first Lissajous figure and each of the M points of the i-th Lissajous figure. Specifically, the signal processing apparatus 100 calculates a distance between the point Aₖ and the point Bₖ₊ⱼ with respect to each integer k that satisfies 1≤k≤M−j, calculates a distance between the point Aₖ and the point B_{k+j-M} with respect to each integer k that satisfies M−j<k≤M, and calculates SD; by adding these distances using Expression (3).

$$S {D}_{j} = {\sum }_{k = 1}^{M - j} \sqrt{{( {X}_{1 \cdot k} - {X}_{i ( k + j )} )}^{2} + {( {Y}_{1 \cdot k} - {Y}_{i ( k + j )} )}^{2}} + {\sum }_{k = M - j + 1}^{M} \sqrt{{( {X}_{1 k} - {X}_{i ( k + j - M )} )}^{2} + {( {Y}_{1 k} - {Y}_{i ( k + j - M )} )}^{2}} \qquad ( 3 )$$

Alternatively, the signal processing apparatus 100 may calculate the distance between the point Aₖ₊ⱼ and the point Bₖ with respect to each integer k that satisfies 1≤k≤M−j, calculate the distance between the point A_{k+j-M} and the point Bₖ with respect to each integer k that satisfies M−j<k≤M, and calculate SD; by adding these distances using Expression (4).

$$S {D}_{j} = {\sum }_{k = 1}^{M - j} \sqrt{{( {X}_{1 ( k + j )} - {X}_{ik} )}^{2} + {( {Y}_{1 ( k + j )} - {Y}_{ik} )}^{2}} + {\sum }_{k = M - j + 1}^{M} \sqrt{{( {X}_{1 ( k + j - M )} - {X}_{ik} )}^{2} + {( {Y}_{1 ( k + j - M )} - {Y}_{ik} )}^{2}} \qquad ( 4 )$$

When the first Lissajous figure and the i-th Lissajous figure are drawn in a three-dimensional space formed by an X axis, a Y axis, and a Z axis, the signal processing apparatus 100 can calculate SDⱼ using Expression (5) or Expression (6).

$$S {D}_{j} = {\sum }_{k = 1}^{M - j} \sqrt{\begin{matrix}{( {X}_{1 k} - {X}_{i \cdot ( k + j )} )}^{2} + \\ {( {Y}_{1 k} - {Y}_{i ( k + j )} )}^{2} + \\ {( {Z}_{1 k} - {Z}_{i ( k + j )} )}^{2}\end{matrix}} + {\sum }_{k = M - j + 1}^{M} \text{} \sqrt{\begin{matrix}{( {X}_{1 k} - {X}_{i ( k + j - M )} )}^{2} + \\ {( {Y}_{1 k} - {Y}_{i ( k + j - M )} )}^{2} + \\ {( {Z}_{1 k} - {Z}_{i ( k + j - M )} )}^{2}\end{matrix}} \qquad ( 5 )$$

$$S {D}_{j} = {\sum }_{k = 1}^{M - j} \sqrt{\begin{matrix}{( {X}_{1 ( k + j )} - {X}_{ik} )}^{2} + \\ {( {Y}_{1 ( k + j )} - {Y}_{ik} )}^{2} + \\ {( {Z}_{1 ( k + j )} - {Z}_{ik} )}^{2}\end{matrix}} + {\sum }_{k = M - j + 1}^{M} \sqrt{\begin{matrix}{( {X}_{1 ( k + j - M \}} - {X}_{ik} )}^{2} + \\ {( {Y}_{1 ( k + j - M )} - {Y}_{ik} )}^{2} + \\ {( {Z}_{1 ( k + j - M )} - {Z}_{ik} )}^{2}\end{matrix}} \qquad ( 6 )$$

Then, when SDⱼ<SDₘᵢₙ in step S65, the signal processing apparatus 100 sets SDₘᵢₙ=SDⱼ in step S66.

The signal processing apparatus 100 increments the integer j by 1 in step S68 and repeatedly performs steps S64 to S66 until the integer j becomes M−1 in step S67. Then, when the integer j becomes M−1 in step S67, the signal processing apparatus 100 finally calculates the degree of difference Dᵢ₋₁ by dividing SDₘᵢₙ by the area of the first Lissajous figure in step S69. Note that SDₘᵢₙ may be the degree of difference Dᵢ₋₁.

As described above, for each integer i from 2 to N, the signal processing apparatus 100 calculates the degree of difference Dᵢ₋₁ based on the sums SD₀ to SD_{M-1} of the distances between each of the M points of the first Lissajous figure and each of the M points of the i-th Lissajous figure in step S60 in FIG. 1. The signal processing apparatus 100 calculates N−1 degrees of difference D₁ to D_{N-1} by performing step S60 in FIG. 1 at N−1 times. The degrees of difference D₁ to D_{N-1} are an example of “first to (N−1)-th degrees of difference”.

### 1-1-2. Signal Processing Apparatus

FIG. 4 shows a configuration example of the signal processing apparatus 100 that executes the signal processing method of the first embodiment. As shown in FIG. 4, the signal processing apparatus 100 includes a physical quantity sensor 200, an analog front-end 210, a processing circuit 110, a storage circuit 120, an operation unit 130, a display unit 140, sound output unit 150, and a communication unit 160. The signal processing apparatus 100 may have a configuration in which part of the component elements in FIG. 4 are omitted or changed, or other component elements are added. For example, the physical quantity sensor 200 and the analog front-end 210 are not necessarily the component elements of the signal processing apparatus 100.

The physical quantity sensor 200 detects a physical quantity generated by a vibration of an object and outputs a signal having magnitude corresponding to the detected physical quantity. An output signal of the physical quantity sensor 200 is input to the analog front-end 210.

The analog front-end 210 performs amplification processing, A/D conversion processing, and the like on the output signal of the physical quantity sensor 200 and outputs a digital time-series signal.

The processing circuit 110 acquires a digital time-series signal output from the physical quantity sensor 200 and output from the analog front-end 210 in the first period as measurement data for the first period, and performs signal processing. Further, the processing circuit 110 acquires a digital time-series signal output from the physical quantity sensor 200 and output from the analog front-end 210 in the i-th period as measurement data for the i-th period with respect to each integer i from 2 to N, and performs signal processing. That is, the processing circuit 110 acquires measurement data for the first to N-th periods and performs signal processing. Specifically, the processing circuit 110 executes a signal processing program 121 stored in the storage circuit 120 and executes various kinds of calculation processing on the measurement data in the first to N-th periods. In addition, the processing circuit 110 executes various types of processing according to operation signals from the operation unit 130, processing of transmitting display signals for the display unit 140 to display various types of information, processing of transmitting sound signals for the sound output unit 150 to generate various sounds, processing of controlling the communication unit 160 for data communication with an external device (not shown), or the like. The processing circuit 110 is implemented by, for example, a CPU or a DSP. CPU is an abbreviation for Central Processing Unit, and DSP is an abbreviation for Digital Signal Processor.

The processing circuit 110 functions as a measurement data acquisition circuit 111, a Lissajous figure generation circuit 112, and a degree of difference calculation circuit 113 by executing the signal processing program 121. That is, the signal processing apparatus 100 includes the measurement data acquisition circuit 111, the Lissajous figure generation circuit 112, and the degree of difference calculation circuit 113.

The measurement data acquisition circuit 111 acquires measurement data based on the physical quantity detected by the physical quantity sensor 200 in the first period. Further, the measurement data acquisition circuit 111 acquires the measurement data based on the physical quantity generated by the vibration of the object detected by the physical quantity sensor 200 in the i-th period for each integer i from 2 to N. The N is an integer of two or more. That is, the measurement data acquisition circuit 111 executes step S10 and step S40 in FIG. 1. The measurement data for the first to N-th periods acquired by the measurement data acquisition circuit 111 is stored in the storage circuit 120.

The Lissajous figure generation circuit 112 generates a first Lissajous figure based on the measurement data for the first period acquired by the measurement data acquisition circuit 111. That is, the Lissajous figure generation circuit 112 generates the first Lissajous figure based on the physical quantity generated by the vibration of the object in the first period. The Lissajous figure generation circuit 112 generates an i-th Lissajous figure for each integer i from 2 to N based on the measurement data for the i-th period acquired by the measurement data acquisition circuit 111. That is, the Lissajous figure generation circuit 112 generates the i-th Lissajous figure based on the physical quantity generated by the vibration of the object in the i-th period. In this manner, the Lissajous figure generation circuit 112 executes step S20 and step S50 in FIG. 1. The first to N-th Lissajous figures generated by the Lissajous figure generation circuit 112 are stored in the storage circuit 120.

The degree of difference calculation circuit 113 calculates a degree of difference Dᵢ₋₁ between the first Lissajous figure and the i-th Lissajous figure generated by the Lissajous figure generation circuit 112 for each integer i from 2 to N. The degree of difference calculation circuit 113 may calculate the degree of difference Dᵢ₋₁ based on the sum of distances between each of the M points of the first Lissajous figure and each of the M points of the i-th Lissajous figure for each integer i from 2 to N. The N is an integer of two or more. That is, the degree of difference calculation circuit 113 executes step S60 in FIG. 1, specifically, steps S61 to S69 in FIG. 2. The degrees of difference D₁ to D_{N-1} generated by the degree of difference calculation circuit 113 are stored in the storage circuit 120.

As described above, the signal processing program 121 is a program for the signal processing apparatus 100 as a computer to execute each procedure of the flowcharts shown in FIGS. 1 and 2.

The storage circuit 120 includes a ROM and a RAM (not shown). ROM is an abbreviation for Read Only Memory, and RAM is an abbreviation for Random Access Memory. The ROM stores various programs including the signal processing program 121 and predetermined data, and the RAM stores data generated by the processing circuit 110. The RAM is also used as a work area of the processing circuit 110, and stores programs and data read from the ROM, data input from the operation unit 130, and data temporarily generated by the processing circuit 110.

The operation unit 130 is an input device including an operation key, a button switch, or the like, and outputs an operation signal corresponding to an operation by a user to the processing circuit 110.

The display unit 140 is a display device including an LCD, or the like, and displays various types of information based on display signals output from the processing circuit 110. LCD is an abbreviation for Liquid Crystal Display. The display unit 140 may be provided with a touch panel that functions as the operation unit 130. For example, the display unit 140 may display a screen including at least part of the first to N-th Lissajous figures and the degrees of difference D₁ to D_{N-1} based on a display signal output from the processing circuit 110.

The sound output unit 150 includes a speaker, and generates various sounds based on sound signals output from the processing circuit 110. For example, the sound output unit 150 may generate a sound indicating the start or end of the signal processing based on the sound signal output from the processing circuit 110.

The communication unit 160 performs various types of control for establishing data communication between the processing circuit 110 and an external device. For example, the communication unit 160 may transmit information including at least part of the first to N-th Lissajous figures and the degrees of difference D₁ to D_{N-1} to an external device, and the external device may display at least part of the received information on a display (not shown).

At least a part of the measurement data acquisition circuit 111, the Lissajous figure generation circuit 112, and the degree of difference calculation circuit 113 may be implemented by dedicated hardware. The signal processing apparatus 100 may be a single device or may be implemented by a plurality of devices. For example, a first device may include the physical quantity sensor 200 and the analog front-end 210, and a second device separate from the first device may include the processing circuit 110, the storage circuit 120, the operation unit 130, the display unit 140, the sound output unit 150, and the communication unit 160. Further, for example, the processing circuit 110 and the storage circuit 120 may be implemented by a device such as a cloud server, and the device may generate the information of the first to N-th Lissajous figures and the degrees of difference D₁ to D_{N-1} and transmit the generated information to a terminal including the operation unit 130, the display unit 140, the sound output unit 150, and the communication unit 160 via a communication line.

### 1-1-3. Functions and Effects

In the above described signal processing method of the first embodiment, when the vibration state including amplitude, frequency, and phase of the vibration of the object is normal in the first period and an abnormality occurs in the vibration state of the object in the i-th period, the difference between the vibration state in the first period and the vibration state in the i-th period generally becomes larger regardless of the type of abnormality. Since the deviation of the i-th Lissajous figure from the first Lissajous figure tends to be larger as the difference between the vibration state of the object in the first period and the vibration state of the object in the i-th period is larger, the degree of difference Dᵢ₋₁ becomes larger based on the sum of the distances between each point of the first Lissajous figure and each point of the i-th Lissajous figure. Therefore, according to the signal processing method of the first embodiment, the signal processing apparatus 100 can calculate the degrees of difference D₁ to D_{N-1} as indexes with which the user can determine the presence or absence of an abnormality even when an unexpected abnormality occurs in the vibration state of the object in the second to N-th periods. Further, it is not necessary for the signal processing apparatus 100 to store Lissajous figures corresponding to expected abnormality modes in advance.

### 1-2. Second Embodiment

As below, regarding a second embodiment, the same component elements as those of the first embodiment have the same signs, overlapping description with the first embodiment will be omitted or simplified, and differences from the first embodiment will be mainly described.

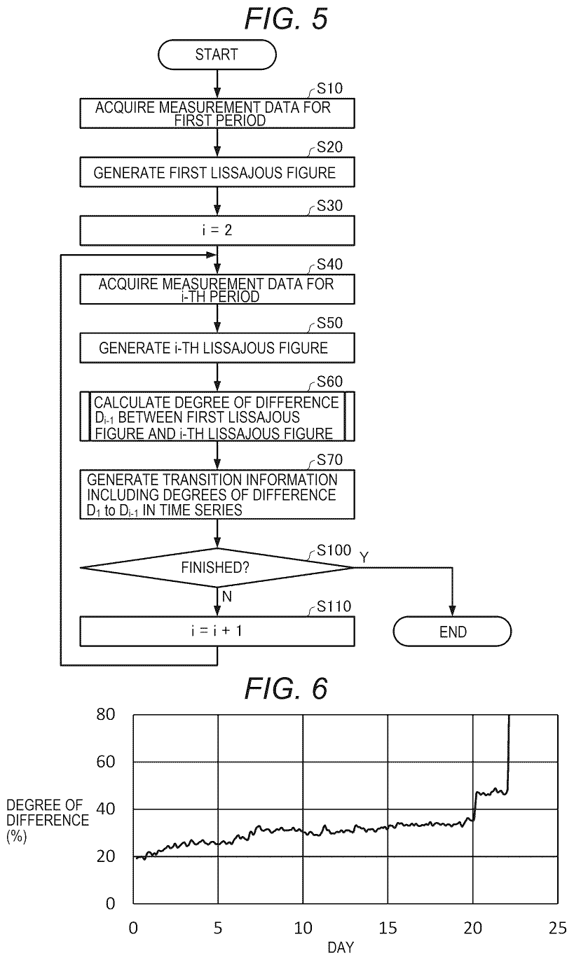

FIG. 5 is a flowchart showing a procedure of a signal processing method of the second embodiment. The signal processing method of the second embodiment is executed by, for example, the signal processing apparatus 100 operating according to a signal processing program. A configuration example of the signal processing apparatus 100 that executes the signal processing method according to the second embodiment will be described later.

As shown in FIG. 5, first, the signal processing apparatus 100 executes steps S10 to S60 as in the first embodiment. Since the detailed procedure of step S60 is the same as that in FIG. 2, illustration and description thereof will be omitted. In the embodiment, the vibrations in the respective first to N-th periods are vibrations generated by motions of the same object.

Then, in step S70, the signal processing apparatus 100 generates transition information including the degrees of difference D₁ to D_{N-1} calculated in step S60 in time series for an integer N=i. The N is an integer of three or more. FIG. 6 is a graph showing an example of the transition information. In the example in FIG. 6, the degree of difference gradually increases from about 20% to about 30% from day 0 to about day 10, and the object is in an “initial progress” state. From about day 10 to about day 19, the degree of difference hardly changes in a range from about 30% to about 35%, and the object is in a “retention” state. On day 20, the degree of difference sharply increases to near 50%, and after day 20, the object is in an “end progress” state. The user can determine that an abnormality occurs in the object on day 20 from the graph of the transition information shown in FIG. 6.

Then, the signal processing apparatus 100 increments the integer i by 1 in step S110 and repeatedly performs steps S40 to S70 until the signal processing is finished in step S100.

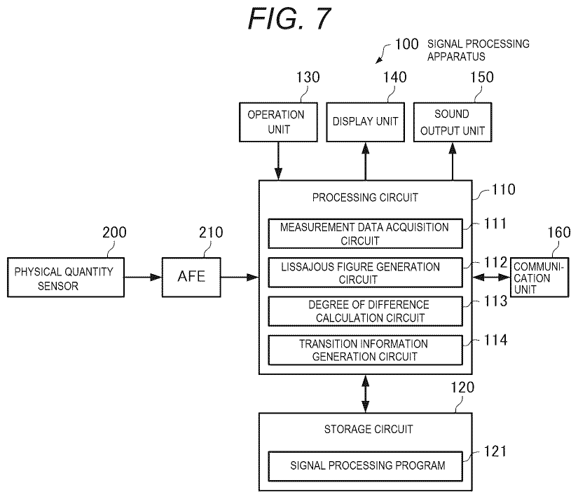

FIG. 7 shows a configuration example of the signal processing apparatus 100 that executes the signal processing method of the second embodiment. As shown in FIG. 7, the signal processing apparatus 100 includes the physical quantity sensor 200, the analog front-end 210, the processing circuit 110, the storage circuit 120, the operation unit 130, the display unit 140, the sound output unit 150, and the communication unit 160. The signal processing apparatus 100 may have a configuration in which part of the component elements in FIG. 7 are omitted or changed, or other component elements are added. For example, the physical quantity sensor 200 and the analog front-end 210 are not necessarily the component elements of the signal processing apparatus 100.

Since the configurations and functions of the physical quantity sensor 200, the analog front-end 210, the storage circuit 120, the operation unit 130, the display unit 140, the sound output unit 150, and the communication unit 160 are the same as those in the first embodiment, the description thereof will be omitted.

The processing circuit 110 functions as the measurement data acquisition circuit 111, the Lissajous figure generation circuit 112, the degree of difference calculation circuit 113, and a transition information generation circuit 114 by executing the signal processing program 121 stored in the storage circuit 120. That is, the signal processing apparatus 100 includes the measurement data acquisition circuit 111, figure the Lissajous generation circuit 112, the degree of difference calculation circuit 113, and the transition information generation circuit 114.

The measurement data acquisition circuit 111 executes step S10 and step S40 in FIG. 5. The Lissajous figure generation circuit 112 executes step S20 and step S50 in FIG. 5. The degree of difference calculation circuit 113 executes step S60 in FIG. 5, specifically, steps S61 to S69 in FIG. 2. Since the functions of the measurement data acquisition circuit 111, the Lissajous figure generation circuit 112, and the degree of difference calculation circuit 113 are the same as those of the first embodiment, the description thereof will be omitted.

The transition information generation circuit 114 generates transition information including the degrees of difference D₁ to D_{N-1} calculated by the degree of difference calculation circuit 113 in time series. The N is an integer of three or more. That is, the transition information generation circuit 114 executes step S70 in FIG. 5. The transition information generated by the transition information generation circuit 114 is stored in the storage circuit 120.

The display unit 140 may display a screen including at least part of the first to N-th Lissajous figures, the degrees of difference D₁ to D_{N-1}, and the transition information based on the display signal output from the processing circuit 110.

The communication unit 160 may transmit information including at least part of the first to N-th Lissajous figures, the degrees of difference D₁ to D_{N-1}, and the transition information to an external device, and the external device may display at least part of the received information on a display (not shown).

At least part of the measurement data acquisition circuit 111, the Lissajous figure generation circuit 112, the degree of difference calculation circuit 113, and the transition information generation circuit 114 may be implemented by dedicated hardware.

The other configurations of the signal processing apparatus 100 in the second embodiment are the same as those in the first embodiment, and thus the description thereof will be omitted.

In the embodiment, the object whose physical quantity is detected in the first period is the same as the object whose physical quantity is detected in the i-th period. That is, the transition information includes the degrees of difference D₁ to D_{N-1} calculated for one object in time series. The physical quantity sensor 200 that outputs the measurement data for the first period and the physical quantity sensor 200 that outputs the measurement data for the i-th period are preferably the same sensor, but may be different sensors that detect the same type of physical quantity.

According to the above described signal processing method of the second embodiment, the same effects as those of the signal processing method of the first embodiment can be obtained. Further, according to the signal processing method of the second embodiment, when the object changes from the normal vibration state to the abnormal vibration state in the i-th period, the degree of difference Dᵢ₋₁ sharply increases, and thus the user can grasp the time when the object changes to the abnormal vibration state based on the transition information including the degrees of difference D₁ to D_{N-1} in time series.

### 1-3. Third Embodiment

As below, regarding a third embodiment, the same component elements as those of the first embodiment or the second embodiment have the same signs, the overlapping description with the first embodiment or the second embodiment will be omitted or simplified, and differences from the first embodiment or the second embodiment will be mainly described.

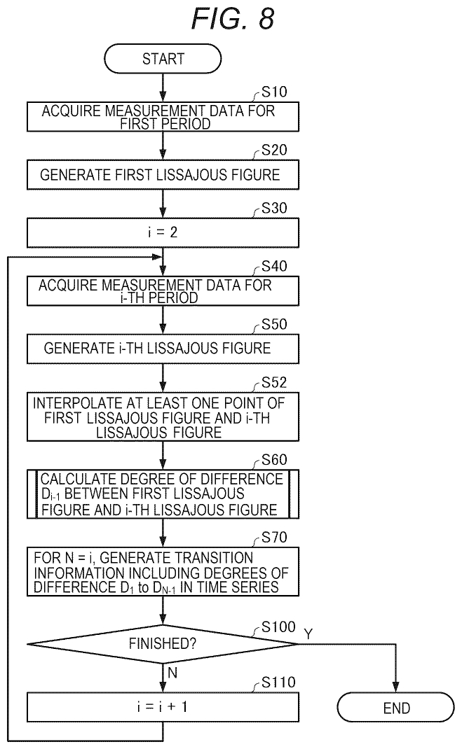

FIG. 8 is a flowchart showing a procedure of a signal processing method of the third embodiment. The signal processing method of the third embodiment is executed by, for example, the signal processing apparatus 100 operating according to a signal processing program. A configuration example of the signal processing apparatus 100 that executes the signal processing method of the third embodiment will be described later.

As shown in FIG. 8, first, the signal processing apparatus 100 executes steps S10 to S50 as in the first embodiment or the second embodiment.

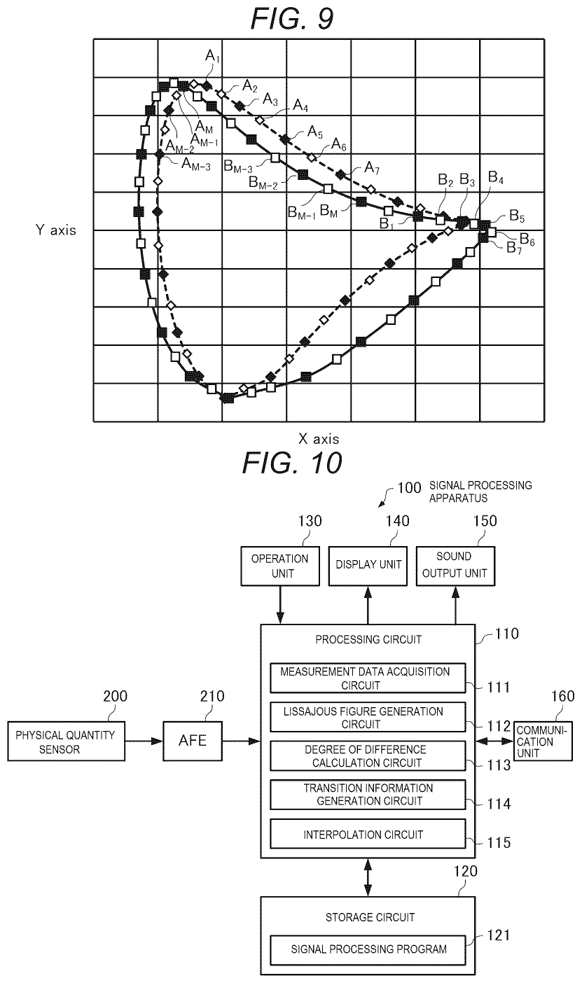

Then, in step S52, the signal processing apparatus 100 calculates coordinates of part of the M points by interpolation for at least one of the first Lissajous figure generated in step S20 and the i-th Lissajous figure generated in step S50. For example, as shown in FIG. 9, in a two-dimensional plane formed by an X axis and a Y axis, a first Lissajous figure indicated by a broken line generated in step S20 includes a plurality of black points A₁, A₃, A₅, . . . , A_{M-3}, A_{M-1}, and an i-th Lissajous figure indicated by a solid line generated in step S50 includes a plurality of black points B₁, B₃, B₅, . . . , B_{M-3}, B_{M-1}. The signal processing apparatus 100 generates a first Lissajous figure including M points A₁ to A_{M} by interpolating white points A₂, A₄, A₆, . . . , A_{M-2}, A_{M} between the respective two points for the first Lissajous figure, and generates an i-th Lissajous figure including M points B₁ to B_{M} by interpolating white points B₂, B₄, B₆, . . . , B_{M-2}, BM between the respective two points for the i-th Lissajous figure. For example, these interpolation may be spline interpolation.

Then, in step S60, the signal processing apparatus 100 calculates a degree of difference Dᵢ₋₁ between the first Lissajous figure generated in step S20 and interpolated in step S52 as necessary and the i-th Lissajous figure generated in step S50 and interpolated in step S52 as necessary. Since the detailed procedure of step S60 is the same as that in FIG. 2, illustration and description thereof will be omitted.

Then, the signal processing apparatus 100 executes step S70 as in the second embodiment. Then, the signal processing apparatus 100 increments the integer i by 1 in step S110 and repeatedly performs steps S40 to S70 until the signal processing is finished in step S100.

FIG. 10 shows a configuration example of the signal processing apparatus 100 that executes the signal processing method of the third embodiment. As shown in FIG. 10, the signal processing apparatus 100 includes the physical quantity sensor 200, the analog front-end 210, the processing circuit 110, the storage circuit 120, the operation unit 130, the display unit 140, the sound output unit 150, and the communication unit 160. The signal processing apparatus 100 may have a configuration in which part of the component elements in FIG. 10 are omitted or changed, or other component elements are added. For example, the physical quantity sensor 200 and the analog front-end 210 are not necessarily the component elements of the signal processing apparatus 100.

Since the configurations and functions of the physical quantity sensor 200, the analog front-end 210, the storage circuit 120, the operation unit 130, the display unit 140, the sound output unit 150, and the communication unit 160 are the same as those in the first embodiment or the second embodiment, the description thereof will be omitted.

The processing circuit 110 functions as the measurement data acquisition circuit 111, the Lissajous figure generation circuit 112, the degree of difference calculation circuit 113, the transition information generation circuit 114, and an interpolation circuit 115 by executing the signal processing program 121 stored in the storage circuit 120. That is, the signal processing apparatus 100 includes the measurement data acquisition circuit 111, the Lissajous figure generation circuit 112, the degree of difference calculation circuit 113, the transition information generation circuit 114, and the interpolation circuit 115.

The measurement data acquisition circuit 111 executes step S10 and step S40 in FIG. 8. The Lissajous figure generation circuit 112 executes step S20 and step S50 in FIG. 8. The degree of difference calculation circuit 113 executes step S60 in FIG. 8, specifically, steps S61 to S69 in FIG. 2. The transition information generation circuit 114 executes step S70 in FIG. 8. The functions of the measurement data acquisition circuit 111, the Lissajous figure generation circuit 112, and the degree of difference calculation circuit 113 are the same as those of the first embodiment or the second embodiment, and the function of the transition information generation circuit 114 is the same as that of the second embodiment, and thus the description thereof will be omitted.

The interpolation circuit 115 calculates coordinates of part of M points by interpolation for at least one of the first Lissajous figure and the i-th Lissajous figure generated by the Lissajous figure generation circuit 112. For example, the interpolation may be spline interpolation.

The display unit 140 may display a screen including at least part of the first to N-th Lissajous figures, the degrees of difference D₁ to D_{N-1}, and the transition information based on the display signal output from the processing circuit 110.

The communication unit 160 may transmit information including at least part of the first to N-th Lissajous figures, the degrees of difference D₁ to D_{N-1}, and the transition information to an external device, and the external device may display at least part of the received information on a display (not shown).

At least part of the measurement data acquisition circuit 111, the Lissajous figure generation circuit 112, the degree of difference calculation circuit 113, the transition information generation circuit 114, and the interpolation circuit 115 may be implemented by dedicated hardware.

Since the other configurations of the signal processing apparatus 100 in the third embodiment are the same as those in the first embodiment or the second embodiment, the description thereof will be omitted.

In the embodiment, the physical quantity sensor 200 that outputs the measurement data for the first period and the physical quantity sensor 200 that outputs the measurement data for the i-th period may be the same or different. In the latter case, the two physical quantity sensors 200 may detect the same type of physical quantity. The object whose physical quantity is detected in the first period and the object whose physical quantity is detected in the i-th period may be the same or different. In the latter case, the two objects may be objects of the same type, for example, devices of the same model number.

According to the above described signal processing method of the third embodiment, the same effects as those of the signal processing method of the first embodiment or the second embodiment can be obtained. Further, according to the signal processing method of the third embodiment, for example, even when the number of points of the first Lissajous figure and the number of points of the i-th Lissajous figure are different from each other, the signal processing apparatus 100 can set the numbers of points to be equal, and thus can correctly calculate the degree of difference Dᵢ₋₁. Furthermore, according to the signal processing method of the third embodiment, for example, even when the number of points of the first Lissajous figure and the number of points of the i-th Lissajous figure are smaller, the signal processing apparatus 100 can increase the numbers of points, and thus can increase the calculation accuracy of the degree of difference Dᵢ₋₁.

### 1-4. Fourth Embodiment

As below, regarding a fourth embodiment, the same component elements as those in the first to third embodiments have the same signs, the overlapping description with those of one of the first to third embodiments will be omitted or simplified, and differences from any one of the first to third embodiments will be mainly described.

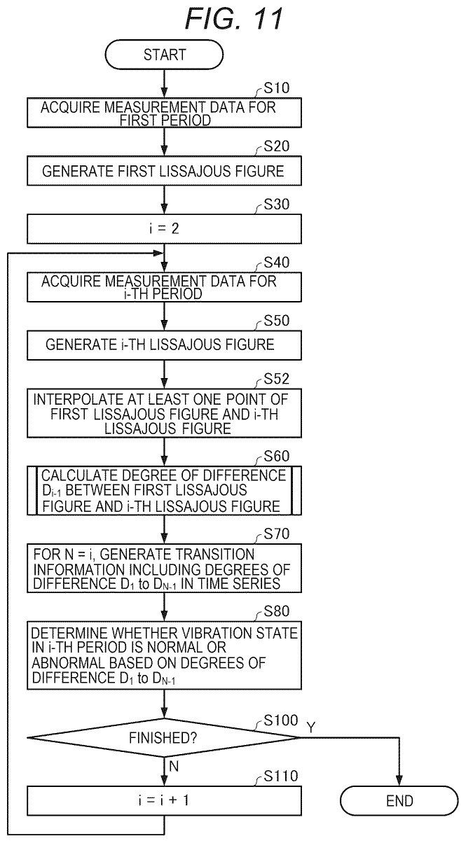

FIG. 11 is a flowchart showing a procedure of a signal processing method of the fourth embodiment. The signal processing method of the fourth embodiment is executed by, for example, the signal processing apparatus 100 operating according to a signal processing program. A configuration example of the signal processing apparatus 100 that executes the signal processing method of the fourth embodiment will be described later.

As shown in FIG. 11, first, the signal processing apparatus 100 executes steps S10 to S70 as in any one of the first to third embodiments.

Then, in step S80, the signal processing apparatus 100 determines whether the vibration state in the i-th period is normal or abnormal based on the degrees of difference D₁ to D_{N-1} calculated in step S60. For example, the signal processing apparatus 100 may compare the degree of difference Dᵢ₋₁ with a predetermined threshold for each integer i from 2 to N, determine that the vibration state in the i-th period is normal when the degree of difference Dᵢ₋₁ is smaller than the threshold, and determine that the vibration state in the i-th period is abnormal when the degree of difference Dᵢ₋₁ is equal to or larger than the threshold. Alternatively, the signal processing apparatus 100 may determine that the vibration state is abnormal when the increase rate of the degree of difference Dᵢ₋₁ to the degree of difference Dᵢ₋₂ is equal to or larger than a predetermined threshold based on the transition information including the degrees of difference D₁ to D_{N-1} in time series generated in step S70.

Then, the signal processing apparatus 100 increments the integer i by 1 in step S110 and repeatedly performs steps S40 to S80 until the signal processing is finished in step S100.

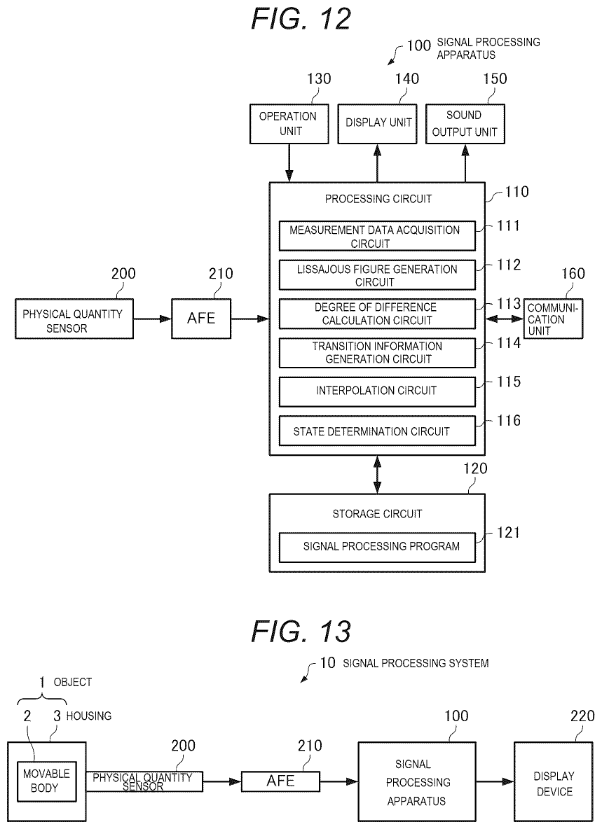

FIG. 12 shows a configuration example of the signal processing apparatus 100 that executes the signal processing method of the fourth embodiment. As shown in FIG. 12, the signal processing apparatus 100 includes the physical quantity sensor 200, the analog front-end 210, the processing circuit 110, the storage circuit 120, the operation unit 130, the display unit 140, the sound output unit 150, and the communication unit 160. The signal processing apparatus 100 may have a configuration in which part of the component elements in FIG. 12 are omitted or changed, or other component elements are added. For example, the physical quantity sensor 200 and the analog front-end 210 are not necessarily the component elements of the signal processing apparatus 100.

Since the configurations and functions of the physical quantity sensor 200, the analog front-end 210, the storage circuit 120, the operation unit 130, the display unit 140, the sound output unit 150, and the communication unit 160 are the same as those in any one of the first to third embodiments, the description thereof will be omitted.

The processing circuit 110 functions as the measurement data acquisition circuit 111, the Lissajous figure generation circuit 112, the degree of difference calculation circuit 113, the transition information generation circuit 114, the interpolation circuit 115, and a state determination circuit 116 by executing the signal processing program 121 stored in the storage circuit 120. That is, the signal processing apparatus 100 includes the measurement data acquisition circuit 111, the Lissajous figure generation circuit 112, the degree of difference calculation circuit 113, the transition information generation circuit 114, the interpolation circuit 115, and the state determination circuit 116.

The measurement data acquisition circuit 111 executes step S10 and step S40 in FIG. 11. The Lissajous figure generation circuit 112 executes step S20 and step S50 in FIG. 11. The degree of difference calculation circuit 113 executes step S60 in FIG. 11, specifically, steps S61 to S69 in FIG. 2. The transition information generation circuit 114 executes step S70 in FIG. 11. The interpolation circuit 115 executes step S52 in FIG. 11. The functions of the measurement data acquisition circuit 111, the Lissajous figure generation circuit 112, and the degree of difference calculation circuit 113 are the same as those of any one of the first to third embodiments, the function of the transition information generation circuit 114 is the same as that of the second or third embodiment, and the function of the interpolation circuit 115 is the same as that of the third embodiment, and thus the description thereof will be omitted.

The state determination circuit 116 determines whether the vibration state in each of the second to N-th periods is normal or abnormal based on the degrees of difference D₁ to D_{N-1} calculated by the degree of difference calculation circuit 113. For example, the state determination circuit 116 may compare the degree of difference Dᵢ₋₁ with a predetermined threshold for each integer i from 2 to N, determine that the vibration state in the i-th period is normal when the degree of difference Dᵢ₋₁ is smaller than the threshold, and determine that the vibration state in the i-th period is abnormal when the degree of difference Dᵢ₋₁ is equal to or larger than the threshold. Alternatively, the state determination circuit 116 may determine that the vibration state is abnormal when the increase rate of the degree of difference Dᵢ₋₁ to the degree of difference Dᵢ₋₂ is equal to or larger than a predetermined threshold value based on the transition information including the degrees of difference D₁ to D_{N-1} in time series generated by the transition information generation circuit 114. The determination result of the vibration state by the state determination circuit 116 is stored in the storage circuit 120.

The display unit 140 may display a screen including at least part of the first to N-th Lissajous figures, the degrees of difference D₁ to D_{N-1}, the transition information, and the determination result of the vibration state based on the display signal output from the processing circuit 110.

The communication unit 160 may transmit information including at least part of the first to N-th Lissajous figures, the degrees of difference D₁ to D_{N-1}, the transition information, and the determination result of the vibration state to an external device, and the external device may display at least part of the received information on a display (not shown).

At least part of the measurement data acquisition circuit 111, the Lissajous figure generation circuit 112, the degree of difference calculation circuit 113, the transition information generation circuit 114, the interpolation circuit 115, and the state determination circuit 116 may be implemented by dedicated hardware.

Since the other configurations of the signal processing apparatus 100 in the fourth embodiment are the same as those in any one of the first to third embodiments, the description thereof will be omitted.

In the embodiment, the physical quantity sensor 200 that outputs the measurement data for the first period and the physical quantity sensor 200 that outputs the measurement data for the i-th period may be the same or different. In the latter case, the two physical quantity sensors 200 may detect the same type of physical quantity. The object whose physical quantity is detected in the first period and the object whose physical quantity is detected in the i-th period may be the same or different. In the latter case, the two objects may be objects of the same type, for example, devices of the same model number.

According to the above described signal processing method of the fourth embodiment, the same effects as those of the signal processing method according to the first to third embodiments can be obtained. According to the signal processing method of the fourth embodiment, since the signal processing apparatus 100 objectively determines whether the vibration state of the object in each of the second to N-th periods is normal or abnormal based on the degrees of difference D₁ to D_{N-1}, the time and effort in determination by the user and variations in the determination result are reduced.

### 2. Signal Processing System

As below, regarding a signal processing system of the embodiment, the same component elements as those described in any one of the above described embodiments have the same signs, the overlapping description with any one of the above described embodiments will be omitted or simplified, and differences from any one of the above described embodiments will be mainly described.

FIG. 13 shows a configuration example of the signal processing system of the embodiment. As shown in FIG. 13, a signal processing system 10 of the embodiment includes the physical quantity sensor 200, the analog front-end 210, the signal processing apparatus 100, and a display device 220.

An object 1 includes a movable body 2 and a housing 3 that houses the movable body 2. The physical quantity sensor 200 is attached to the housing 3, detects a physical quantity generated by a vibration of the object 1 in each of first to N-th periods, and outputs a signal having magnitude corresponding to the detected physical quantity. An output signal of the physical quantity sensor 200 is input to the analog front-end 210.

The analog front-end 210 performs amplification processing, A/D conversion processing, and the like on the output signal of the physical quantity sensor 200 and outputs a digital time-series signal.

The signal processing apparatus 100 acquires a digital time-series signal output from the physical quantity sensor 200 and output from the analog front-end 210 in the first period as measurement data for the first period, and generates a first Lissajous figure based on the measurement data for the first period. For each integer i from 2 to N, the signal processing apparatus 100 acquires a digital time-series signal output from the physical quantity sensor 200 and output from the analog front-end 210 in the i-th period as measurement data for the i-th period, and generates an i-th Lissajous figure based on the measurement data for the i-th period. That is, the signal processing apparatus 100 acquires the measurement data in the first to N-th periods and generates the first to N-th Lissajous figures. Then, the signal processing apparatus 100 calculates a degree of difference Dᵢ₋₁ between the first Lissajous figure and the i-th Lissajous figure for each integer i from 2 to N, generates various types of information based on the calculated degrees of difference D₁ to D_{N-1}, and displays at least part of the various types of information on the display device 220. The display device 220 may be a device separate from the signal processing apparatus 100, or may be a display provided in the signal processing apparatus 100. When the physical quantity sensor 200 outputs a digital time-series signal, the signal processing apparatus 100 may acquire the digital time-series signal, and thus the analog front-end 210 may be omitted. As the signal processing apparatus 100, for example, the signal processing apparatus 100 according to any one of the above described first to fourth embodiments can be applied.

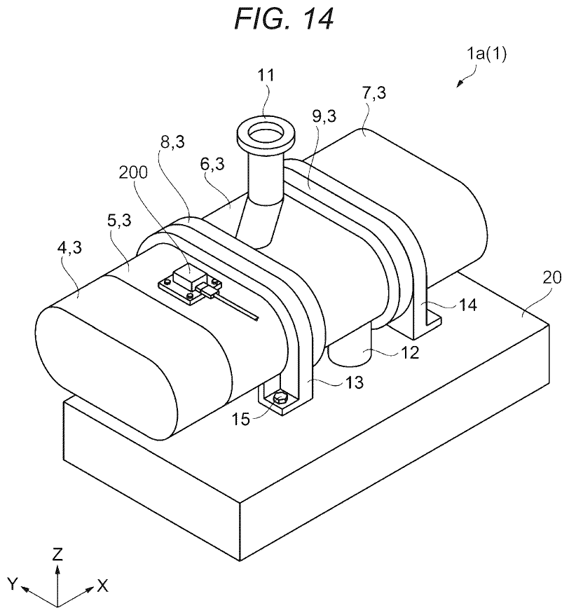

FIG. 14 shows a vacuum pump la as an example of the object 1. As shown in FIG. 14, the vacuum pump la is disposed on a base 20. The vacuum pump la has a columnar shape having a substantially long circle cross section. A longitudinal direction of the vacuum pump la is defined as an X direction. A long axis direction of the long circle is defined as a Y direction, and a short axis direction of the long circle is defined as a Z direction.

The vacuum pump la includes the housing 3. The housing 3 includes a motor case 4, a coupling portion 5, a pump case 6, and a gear case 7 disposed from a −X direction side toward a +X direction side. The housing 3 includes a first side wall 8 as a bearing casing between the coupling portion 5 and the pump case 6. The housing 3 includes a second side wall 9 between the pump case 6 and the gear case 7.

An intake pipe 11 is coupled to a surface of the pump case 6 at a +Z direction side. An exhaust pipe 12 is coupled to a surface of the pump case 6 at a −Z direction side.

The coupling portion 5 includes a first leg portion 13 and a second leg portion at the base 20 side. The first leg portion 13 is disposed at a −Y direction side, and the second leg portion is disposed at a +Y direction side. The gear case 7 includes a third leg portion 14 and a fourth leg portion at the base 20 side. The third leg portion 14 is disposed at the −Y direction side, and the fourth leg portion is disposed at the +Y direction side. The first leg portion 13 to the fourth leg portion are fastened to the base 20 by first bolts 15.

The physical quantity sensor 200 is attached to the housing 3. The physical quantity sensor 200 is attached to, for example, the coupling portion 5. For example, the physical quantity sensor 200 may be a three-axis acceleration sensor that detects an acceleration in the X-axis direction, an acceleration in the Y-axis direction, and an acceleration in the Z-axis direction. For example, the physical quantity sensor 200 may be a three-axis velocity sensor that detects a velocity in the X-axis direction, a velocity in the Y-axis direction, and a velocity in the Z-axis direction.

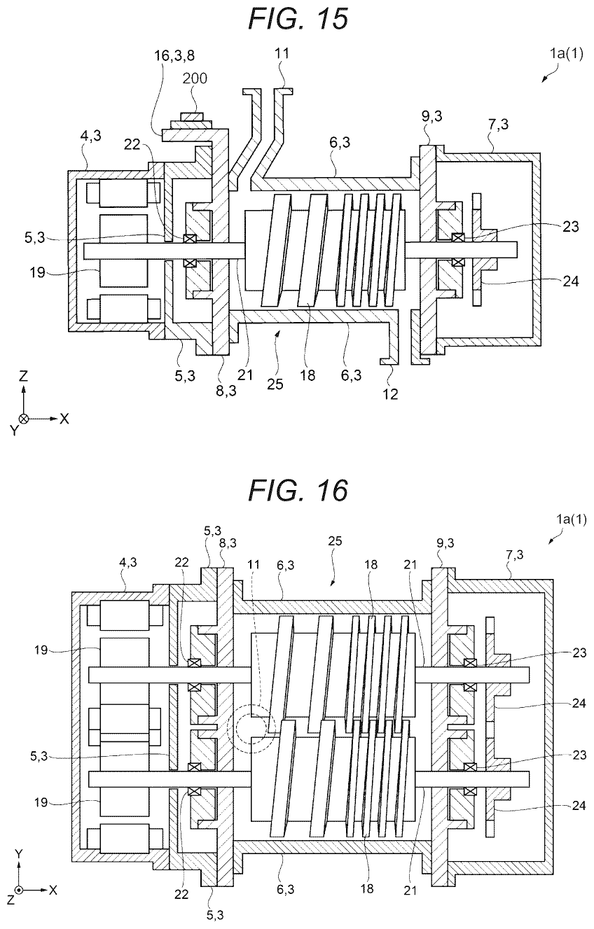

An internal structure of the vacuum pump la will be described with reference to FIGS. 15 and 16. FIG. 15 is a view from the −Y direction. FIG. 16 is a view from the +Z direction. In the drawings, the first leg portion 13 to the fourth leg portion are omitted. The vacuum pump 1a includes pump rotors 18 as two movable bodies 2 that transfer a gas and two motors 19 that rotate the two pump rotors 18. The housing 3 houses the pump rotors 18.

The two pump rotors 18 have two rotation shafts 21. The two rotation shafts 21 are respectively rotatably supported by first bearings 22 and second bearings 23 as bearings. The two motors 19 are coupled to one ends of the respective rotation shafts 21. The motors 19 are configured to rotate the two pump rotors 18 in opposite directions in synchronization with each other. Two timing gears 24 are fixed to the other ends of the rotation shafts 21. The timing gears 24 are provided to ensure the synchronous rotation of the two pump rotors 18 when the synchronous rotation of the two motors 19 is lost.

The pump case 6 is sandwiched between the first side wall 8 and the second side wall 9. The pump rotors 18 are disposed in a pump chamber 25 formed by the pump case 6, the first side wall 8, and the second side wall 9.

The first side wall 8 supports the first bearing 22 at the intake pipe 11 side. The first bearings 22 are disposed in the coupling portion 5. The motors 19 are disposed in the motor case 4 fixed to the coupling portion 5. The second bearing 23 at the exhaust pipe 12 side is fixed to the second side wall 9. The timing gears 24 and the second bearings 23 are disposed in the gear case 7. The rotation of the pump rotors 18 vibrates the first bearings 22 and the second bearings 23. The vibration of the first bearings 22 and the second bearings 23 is transmitted to the housing 3 including the coupling portion 5 via the first side wall 8 and the second side wall 9. The physical quantity sensor 200 detects the vibration transmitted to the housing 3.

According to the signal processing system 10 of the embodiment, the signal processing apparatus 100 can calculate the degrees of difference D₁ to D_{N-1} based on the signals output from the physical quantity sensor 200 in the first to N-th periods and can cause the display device 220 to display various types of information based on the degrees of difference D₁ to D_{N-1}. Therefore, the user can monitor the state of the object 1 based on the information displayed on the display device 220 and accurately make a determination as to whether the state of the object 1 is normal or abnormal or the like.

The signal processing system 10 may include a plurality of physical quantity sensors 200. The plurality of physical quantity sensors 200 may be respectively provided in different objects 1, and each physical quantity sensor 200 may detect a physical quantity generated by a vibration in each of the first to N-th periods.

The present disclosure is not limited to the embodiments, and various modifications can be made within the scope of the gist of the present disclosure.

The above described embodiments and modifications are merely examples, and the present disclosure is not limited thereto. For example, the embodiments and modifications may be combined as appropriate.

The present disclosure includes substantially the same configurations as the configurations described in the embodiments, for example, configurations having the same functions, methods, and results or configurations having the same purposes and effects. The present disclosure includes a configuration in which non-essential portions of the configurations described in the embodiment are replaced. Further, the present disclosure includes a configuration that exerts the same function and effect or a configuration that can achieve the same purpose as the configurations described in the embodiments. Furthermore, the present disclosure includes a configuration with the addition of a known technique to the configuration described in the embodiments.

The following configurations are derived from the above described embodiments and modifications.

A signal processing method according to an aspect includes generating a first Lissajous figure based on a physical quantity generated by a vibration in a first period, generating an i-th Lissajous figure based on a physical quantity generated by a vibration in an i-th period with respect to each integer i from 2 to N, N being an integer of 2 or more, and calculating an (i−1)-th degree of difference as a degree of difference between the first Lissajous figure and the i-th Lissajous figure.

In the signal processing method, when a vibration state including amplitude, frequency, and phase of the vibration is normal in the first period and an abnormality occurs in the vibration state in the i-th period, the difference between the vibration state in the first period and the vibration state in the i-th period generally becomes larger regardless of the type of abnormality, and as a result, the (i−1)-th degree of difference as the degree of difference between the first Lissajous figure and the i-th Lissajous figure becomes larger. Therefore, according to the signal processing method, even when an unexpected abnormality occurs in the vibration states in the second to N-th periods, the first to (N−1)-th degrees of difference as indexes with which the user can determine the presence or absence of an abnormality can be calculated.

In the signal processing method according to the aspect, the vibrations in the respective first to N-th periods may be vibrations generated by motions of a same object, and the integer N may be 3 or more, and transition information including the first to (N−1)-th degrees of difference in time series may be generated.

According to the signal processing method, when the object changes from the normal vibration state to the abnormal vibration state in the i-th period, the (i−1)-th degree of difference sharply increases, and thus the user can grasp the time when the object changes to the abnormal vibration state based on the transition information.

In the signal processing method according to the aspect, whether a state of the vibration in the i-th period is normal or abnormal may be determined based on the first to (N−1)-th degrees of difference.

According to the signal processing method, when the normal vibration state changes to the abnormal vibration state in the i-th period, the i-th degree of difference largely changes, and thus the user or the signal processing apparatus can determine whether the vibration state is normal or abnormal.

In the signal processing method according to the aspect, the (i−1)-th degree of difference may be calculated based on a sum of distances between each of M points of the first Lissajous figure and each of M points of the i-th Lissajous figure, M being an integer of 2 or more.

In the signal processing method, since the deviation of the i-th Lissajous figure from the first Lissajous figure tends to be larger as the difference between the vibration state in the first period and the vibration state in the i-th period is larger, the (i−1)-th degree of difference becomes larger based on the sum of the distances between each point of the first Lissajous figure and each point of the i-th Lissajous figure. Therefore, even when an unexpected abnormality occurs in the vibration state in the i-th period, the (i−1)-th degree of difference as an index with which the user can determine the presence or absence of an abnormality can be calculated.

In the signal processing method according to the aspect, coordinates of part of the M points may be calculated by interpolation for at least one of the first Lissajous figure and the i-th Lissajous figure.

According to the signal processing method, for example, even when the number of points of the first Lissajous figure and the number of points of the i-th Lissajous figure are different from each other, the numbers of points can be set to be equal, and thus the (i−1)-th degree of difference can be correctly calculated. In addition, according to the signal processing method, for example, even when the number of points of the first Lissajous figure and the number of points of the i-th Lissajous figure are smaller, the numbers of points can be increased, and thus the calculation accuracy of the (i−1)-th degree of difference can be increased.

A signal processing apparatus according to an aspect includes a Lissajous figure generation circuit that generates a first Lissajous figure based on a physical quantity generated by a vibration in a first period and generates an i-th Lissajous figure based on a physical quantity generated by a vibration in an i-th period with respect to each integer i from 2 to N, N being an integer of 2 or more, and a degree of difference calculation circuit that calculates an (i−1)-th degree of difference as a degree of difference between the first Lissajous figure and the i-th Lissajous figure.

In the signal processing apparatus, when a vibration state including amplitude, frequency, and phase of the vibration is normal in the first period and an abnormality occurs in the vibration state in the i-th period, the difference between the vibration state in the first period and the vibration state in the i-th period generally becomes larger regardless of the type of abnormality, and as a result, the (i−1)-th degree of difference as the degree of difference between the first Lissajous figure and the i-th Lissajous figure becomes larger. Therefore, according to the signal processing apparatus, even when an unexpected abnormality occurs in the vibration states in the second to N-th periods, the first to (N−1)-th degrees of difference as indexes with which the user can determine the presence or absence of an abnormality can be calculated.

A signal processing system according to an aspect includes the signal processing apparatus according to the aspect, and at least one physical quantity sensor that detects the physical quantity generated by the vibration in each of the first to N-th periods.

A non-transitory computer-readable storage medium storing a signal processing program according to an aspect, in which the program causes a computer to execute generating a first Lissajous figure based on a physical quantity generated by a vibration in a first period, generating an i-th Lissajous figure based on a physical quantity generated by a vibration in an i-th period with respect to each integer i from 2 to N, N being an integer of 2 or more, and calculating an (i−1)-th degree of difference as a degree of difference between the first Lissajous figure and the i-th Lissajous figure.

In the signal processing program, when a vibration state including amplitude, frequency, and phase of the vibration is normal in the first period and an abnormality occurs in the vibration state in the i-th period, the difference between the vibration state in the first period and the vibration state in the i-th period generally becomes larger regardless of the type of abnormality, and as a result, the (i−1)-th degree of difference as the degree of difference between the first Lissajous figure and the i-th Lissajous figure becomes larger. Therefore, according to the signal processing program, even when an unexpected abnormality occurs in the vibration states in the second to N-th periods, the computer can calculate the first to (N−1)-th degrees of difference as indexes with which the user can determine the presence or absence of an abnormality.

What is claimed is:

1. A signal processing method comprising:
generating a first Lissajous figure based on a physical quantity generated by a vibration in a first period;
generating an i-th Lissajous figure based on a physical quantity generated by a vibration in an i-th period with respect to each integer i from 2 to N, N being an integer of 2 or more; and
calculating an (i−1)-th degree of difference as a degree of difference between the first Lissajous figure and the i-th Lissajous figure.

2. The signal processing method according to claim 1, wherein
the vibrations in the respective first to N-th periods are vibrations generated by motions of a same object, and
the integer N is 3 or more, and transition information including the first to (N−1)-th degrees of difference in time series is generated.

3. The signal processing method according to claim 1, wherein
whether a state of the vibration in the i-th period is normal or abnormal is determined based on the first to (N−1)-th degrees of difference.

4. The signal processing method according to claim 1, wherein
the (i−1)-th degree of difference is calculated based on a sum of distances between each of M points of the first Lissajous figure and each of M points of the i-th Lissajous figure, M being an integer of 2 or more.

5. The signal processing method according to claim 4, wherein
coordinates of part of the M points are calculated by interpolation for at least one of the first Lissajous figure and the i-th Lissajous figure.

6. A signal processing apparatus comprising:
a Lissajous figure generation circuit that generates a first Lissajous figure based on a physical quantity generated by a vibration in a first period and generates an i-th Lissajous figure based on a physical quantity generated by a vibration in an i-th period with respect to each integer i from 2 to N, N being an integer of 2 or more; and
a degree of difference calculation circuit that calculates an (i−1)-th degree of difference as a degree of difference between the first Lissajous figure and the i-th Lissajous figure.

7. A signal processing system comprising:
the signal processing apparatus according to claim 6; and
at least one physical quantity sensor that detects the physical quantity generated by the vibration in each of the first to N-th periods.

8. A non-transitory computer-readable storage medium storing a signal processing program causing a computer to execute:
generating a first Lissajous figure based on a physical quantity generated by a vibration in a first period;
generating an i-th Lissajous figure based on a physical quantity generated by a vibration in an i-th period with respect to each integer i from 2 to N, N being an integer of 2 or more; and
calculating an (i−1)-th degree of difference as a degree of difference between the first Lissajous figure and the i-th Lissajous figure.
